(19) United States
(12) Patent Application Publication
(10) Pub. No.: US 2002/0121019 A1
(43) Pub. Date: Sep. 5, 2002

(54) Method of assembling starter lead wire

(75) Inventors: Youichi Hasegawa, Kasugai-city (JP); Yasuo Osawa, Nitta-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/046,176

(22) Filed: Jan. 16, 2002

(30) Foreign Application Priority Data
Mar. 1, 2001 (JP) 2001-056795

(51) Int. Cl. H01R 43/00; H02K 15/14

(52) U.S. Cl. 29/857; 29/596

(57) ABSTRACT

In electrically connecting a starting motor and a magnet switch, a lead wire is shaped into a substantially V-shape. Then, the lead wire is arranged in a molding die and a sleeve is integrally molded with the lead wire. A seal portion of the sleeve fluid-tightly engages with insertion portions of a yoke and an end frame of the motor. While assembling the starting motor and the magnet switch, it is unnecessary to manually bend the lead wire during connection of the lead wire. Therefore, deformation of the seal portion is decreased, thereby maintaining the starting motor to be waterproof and facilitating the assembly of the starting motor.

### CROSS REFERENCE TO RELATED APPLICATION

This application relates to and incorporates herein by reference Japanese Patent Application No. 2001-56795 filed on Mar. 1, 2001.

### FIELD OF THE INVENTION

The present invention relates to a method of assembling a lead wire of a starter to facilitate assembling of the starter.

### BACKGROUND OF THE INVENTION

In recent years, with downsizing of a starter, heat generation per unit area during starter operation is increased. Therefore, it is required to improve heat radiation of the starter. To meet this requirement, for example, the lead wire electrically connecting an outside and inside of a housing of a starting motor is designed thicker and shorter.

In a starter proposed in JP-A-2-278612, a rubber sleeve is air-tightly integrated with the lead wire by insert molding. Also, the outer periphery of the rubber sleeve is sealed with a housing to maintain waterproofness between the rubber sleeve and the housing. In this starter, the lead wire integrated with the rubber sleeve is connected to a predetermined position by manually bending. However, it is difficult to manually bend the thickened and shortened lead wire, and as a result, assemblability of the starter is lessened. Further, the rubber sleeve around the lead wire tends to be deformed by stress caused by bending the lead wire. Therefore, the sealing structure between the rubber sleeve and the housing is likely to be deformed, and as a result, the waterproofness is worsened.

### SUMMARY OF THE INVENTION

The present invention is made in view of the above problem and it is an object to provide an assembling method of a lead wire of a starter to facilitate an assembly of the starter.

According to an assembling method of a lead wire, the lead wire is prepared beforehand such that the lead wire is bent into a predetermined shape including a first bent portion and a second bent portion. Also, a terminal to be connected to a magnet switch is welded to an end of the second bent portion of the lead wire.

Then, a sleeve is integrally molded with the lead wire. A part of the sleeve which faces the first bent portion of the lead wire is inserted into a housing of a starting motor so that the outer periphery of the sleeve and the housing are sealed.

In this assembling method, the terminal welded to the lead wire is connected to the magnet switch at the time of inserting the sleeve into the housing. Therefore, it is unnecessary to manually bend the lead wire to connect the terminal to the magnet switch when or after the lead wire is inserted into the housing.

### BRIEF DESCRIPTION OF THE DRAWINGS

Other objects, features and advantages of the present invention will become more apparent from the following detailed description made with reference to the accompanying drawings.

In the drawings:

FIG. 1 is a partial external view of a starting motor according to a first embodiment of the present invention;

FIG. 2 is a partial cross-sectional view of a lead wire connecting a magnet switch and a starting motor taken along line II-II of FIG. 1;

FIG. 3 is a partial cross-sectional view of a sealing portion taken along line III-III of FIG. 1;

FIG. 4 is a partial perspective view illustrating positional relationship of a yoke and an end frame of the starting motor according to the first embodiment;

FIG. 5 is an enlarged perspective view of a sleeve integrating an O-ring according to a second embodiment of the present invention;

FIG. 6 is a cross-sectional view of a sleeve taken perpendicularly to an extending direction of the sleeve according to a third embodiment of the present invention;

FIG. 7 is a cross-sectional view of a sleeve according to a fourth embodiment of the present invention.

### DETAILED DESCRIPTION OF PREFERRED EMBODIMENTS

(First Embodiment)

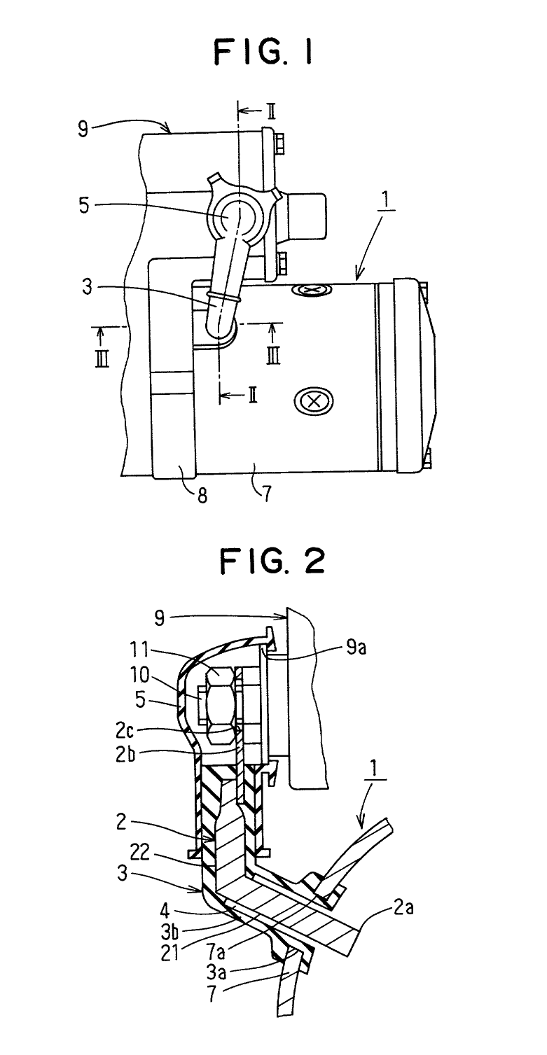

As shown in FIGS. 1 and 2, a starting motor 1 is connected to a magnet switch 9 adjacently provided thereto. The magnet switch 9 is to turn on/off the electric current supply from a battery (not shown) to the starting motor 1.

The lead wire 2 includes a connecting portion 2a at one end formed by welding twisted copper wires of the lead wire 2. The other end of the lead wire 2 is welded to a terminal 2b. The lead wire 2 is bent into a generally V-shape beforehand so as to form a first bent portion 21 including the connecting portion 2a and a second bent portion 22 including the terminal 2b. A bolt 10 is provided at one axial side of the fixed contact posts of the magnet switch 9. The terminal 2b is connected to the bolt 10 by tightening a nut 11 with the bolt 10. A yoke 7 as a housing of the starting motor 1 includes a connecting bar (not shown) connected to field windings (not shown) therein. The connecting portion 2a is connected to the connecting bar by brazing. The lead wire 2 is inserted in a sleeve 3 which insulates the lead wire 2 and prevents entering of water into the starting motor 1.

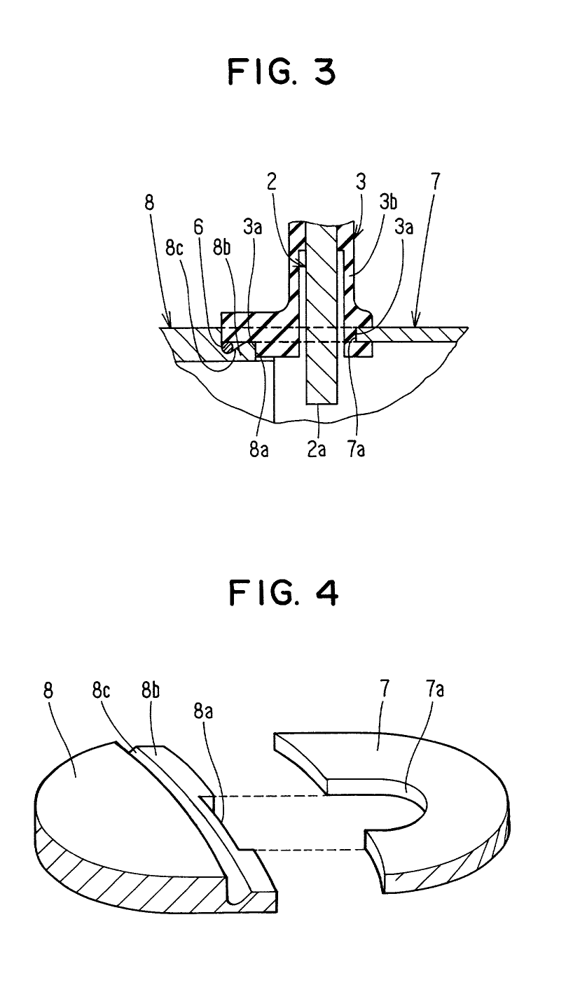

The sleeve 3 is made of an insulation material such as rubber. The sleeve 3 is formed by molding and integrated with the lead wire 2 after the lead wire 2 is bent to a predetermined shape shown in FIG. 2 beforehand. In the predetermined shape, the lead wire 2 connects the starting motor 1 and the magnet switch 9 in a shortest distance, and the terminal 2b of the second bent portion 22 is in parallel with a fixing surface of the bolt 10. At this time, the sleeve 3 fluid-tightly contacts the second bent portion 22 and the terminal 2b. The sleeve 3 includes a thin wall portion 3b at a part that faces the first bent portion 21. The thin wall portion 3b is thinner than the other parts of the sleeve 3. A clearance 4 remains in a substantially cylindrical-shape between the first bent portion 21 of the lead wire 2 and the thin wall portion 3b of the sleeve 3. As shown in FIG. 2, a seal portion 3a is provided on the outer periphery of the sleeve 3 at a position that faces the end portion of the first bent portion 21, in order to prevent entering of water into the starting motor 1. The seal portion 3a has a groove so as to engage with insertion portions 7a and 8a (described later) of the yoke 7 and an end frame 8. Thus, the sleeve 3 is fluid-tightly fixed to the yoke 7 and the end frame 8, as shown in FIGS. 1 and 3.

The terminal 2b includes a through hole 2c. When the sleeve 3 is assembled to the yoke 7 and the end frame 8 through the seal portion 3a, the through hole 2c of the terminal 2b is engaged with the bolt 10 of the magnet switch 9. In this way, the lead wire 2 is readily connected to the magnet switch 9 in the course of assembling of the starting motor 1. Since the sleeve 3 is fluid-tightly fixed to the terminal 2b, it is prevented that water enters the sleeve 3 from this fixing part of the sleeve 3 and the terminal 2b. While assembling of the starting motor 1, for example, if the magnet switch 9 is displaced, it is necessary to slightly adjust the shape of the lead wire 2. At this time, the sleeve 3 is deformed. In this case, because the clearance 4 is provided in the inner periphery of the thinner wall portion 3b, the thin wall portion 3b is mainly deformed, but the seal portion 3a is not generally deformed. Thus, the deformation of the seal portion 3a is decreased by the clearance 4. Therefore, the seal portion 3a can maintain waterproofness.

The yoke 7 and the end frame 8 form a cylindrical housing and accommodate the field windings (not shown) and an armature (not shown) of the starting motor 1 therein. As shown in FIGS. 3 and 4, the end frame 8 is provided with a spigot portion 8b to engage with the inner peripheral surface of the yoke 7. The spigot portion 8b includes an annular groove 8c to fit an O-ring 6 on the same axial line as those of the yoke 7 and the end frame 8. The yoke 7 and the end frame 8 include insertion portions 7a and 8a that define a hole to introduce the lead wire 2 in the starting motor 1, respectively. The insertion portions 7a and 8a engage with the seal portion 3a of the sleeve 3 to make the starting motor waterproof.

When the yoke 7 is fitted to the end frame 8, the O-ring 6 is press-contacted to the annular groove 8c, the inner peripheral surface of the yoke 7 and the seal portion 3a. Therefore, the yoke 7 and the end frame 8 can be fluid-tightly fitted to each other, thereby maintaining waterproofness therebetween.

A cap 5 is made of rubber or resin. As shown in FIG. 2, the cap 5 is fitted on the outer periphery of the sleeve 3 and engaged with an engaging portion 9a of the magnet switch 9. Therefore, the connecting portion between the magnet switch 9 and the lead wire 2 is covered with the cap 5. Accordingly, the connecting portion between the magnet switch 9 and the lead wire 2 is made waterproof.

The sleeve 3 is molded in the following manner.

First, the terminal 2b is bonded to the lead wire 2 by welding and the like, and the connecting portion 2a is formed by welding. Then, this lead wire 2 is bent into the substantially V-shape as shown in FIG. 2. At this stage, the lead wire 2 is shaped into the completed shape that is substantially the same shape as that in the completion of the assembly of the starting motor 1.

Next, the lead wire 2 is placed in a molding die and rubber is then injected into the molding die. Thus, the sleeve 3 is integrally molded with the lead wire 2. While injection-molding, the terminal 2b and the first bent portion 21 of the lead wire 2 are held with the molding die. That is, the lead wire 2 is securely held in the molding die at two positions including the first bent portion 21. Therefore, the lead wire 2 is restricted from moving 5 in the molding die due to injection pressure of the rubber during the rubber injection. As a result, the sleeve 3 is uniformly molded in thickness. Further, since rubber does not stick to a part that is held with the molding die, the clearance 4 is provided on the outer periphery of the first bent portion 21 after removal of the molding die.

The starting motor 1 is assembled in the following manner.

Firstly, each component is set in the following state. The field windings (not shown), the armature (not shown) and brushes (not shown) for supplying electric current to the armature are assembled in the yoke 7. Also, those components are electrically connected. The seal portion 3a of the sleeve 3 is fixed to the insertion portion 7a of the yoke 7. The connecting portion 2a of the lead wire 2 is brazed to the connector bar (not shown) of the field windings. The cover 5 is attached on the sleeve 3 to cover the terminal 2b of the lead wire 2. The O-ring 6 is attached on the annular groove 8c of the end frame 8.

Then, the yoke 7 is engaged with the spigot portion 8b of the end frame 8 while engaging the insertion portion 8a of the end frame 8 with the seal portion 3a, so that the yoke 7 is contacted to the end frame 8. The yoke 7 is then fixed to the end frame 8 by tightening through bolts (not shown).

Next, the lead wire 2 is connected to the magnet switch 9. As already described above, the lead wire 2 is bent into the completed shape shown in FIG. 2 beforehand. When the seal portion 3a of the sleeve 3 is assembled to the yoke 7 and the end frame 8, the through hole 2c of the terminal 2b corresponds to the bolt 10 of the magnet switch 9. Therefore, the terminal 2b is readily set to the bolt 10. After fixing the terminal 2b by tightening the nut 11, the connecting portion including the bolt 10, the nut 11 and the terminal 2b and the like are entirely covered with the cap 5. Then, an opening end portion of the cap 5 is engaged with the annular-shaped engaging portion 9a of the magnet switch 9. Therefore, the entering of water to the bolt 10 and the terminal 2b is prevented.

When the terminal 2b is connected to the bolt 10, even if the through hole 2c of the terminal 2b is displaced from the bolt 10 of the magnet switch 9, an amount of the displacement is small. Therefore, the displacement is manually adjusted so that the terminal 2b is connected to the bolt 10. With this manual adjustment, the sleeve 3 tends to deform. However, only the thin wall portion 3b deforms without causing deformation in the seal portion 3a. Therefore, deformation of the seal portion 3a is suppressed. As a result, the entering of water is prevented between the seal portion 3a, the yoke 7 and the end frame 8.

In the starting motor 1 according to the first embodiment, the sleeve 3 is integrally molded with the lead wire 2 after the lead wire 2 is shaped into the completed bent shape. Then, the seal portion 3a of the sleeve 3 is engaged with the insertion portions 7a and 8a of the yoke 7 and the end frame 8. Therefore, it is unnecessary to manually bend the lead wire 2 in order to connect the terminal 2b to the magnet switch 9 like a conventional lead wire, during the assembly of the starting motor 1. As a result, the seal portion 3a is prevented from being deformed, thereby maintaining waterproofness and facilitating assembling of the starting motor 1.

In addition, the lead wire 2 is bent into the V-shape forming the first bent portion 21 including the connecting portion 2a and the second bent portion 22 including the terminal 2b beforehand.

Further, the clearance 4 is formed between the first bent portion 21 and the sleeve 3. Therefore, in a case that the lead wire 2 is needed to be slightly bent by manual work in order to adjacent the displacement or the like, the deformation of the sleeve 3 is absorbed by the clearance 4. As a result, the seal portion 3a is not deformed, thereby maintaining waterproofness successfully.

(Second Embodiment)

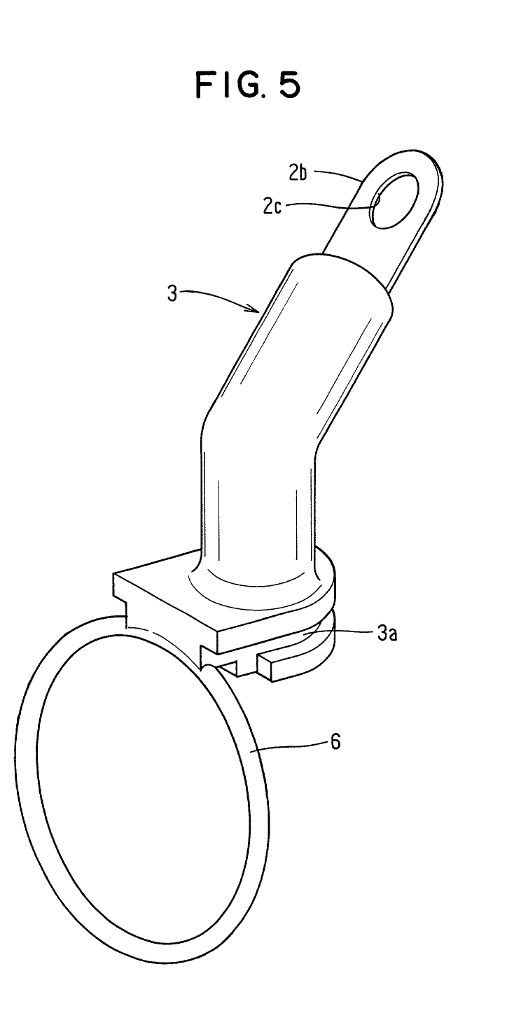

In a second embodiment, the sleeve 3 is integrally formed with the O-ring 6 as shown in FIG. 5. With this arrangement, similar effects to the first embodiment can be obtained. Further, not only the number of components is decreased, but also the assemblability of the starting motor 1 can be improved.

(Third Embodiment)

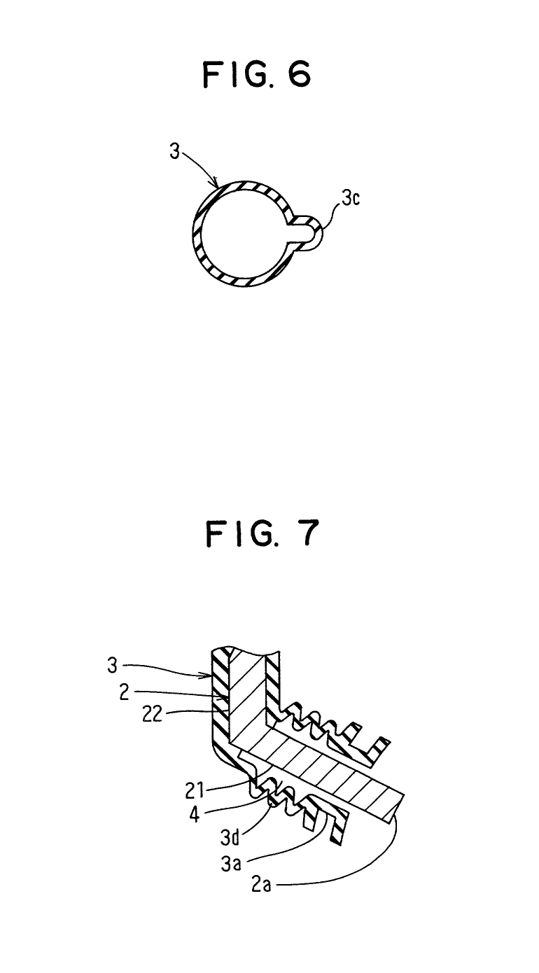

In a third embodiment, the sleeve 3 has a projection 3c as shown in FIG. 6 in addition to or in place of the clearance 4. With this arrangement, in a case that the lead wire 2 is slightly bent to adjust the displacement, the deformation of the sleeve 3 is absorbed by the projection 3c. Therefore, the deformation of the seal portion 3a is restricted, thereby maintaining the starting motor 1 to be waterproof satisfactorily.

(Fourth Embodiment)

In a fourth embodiment, the sleeve 3 has an accordion 3d that faces the first bent portion through the clearance 4, as shown in FIG. 7. Thus, in a case that the lead wire 2 is slightly bent during the assembly of the starting motor 1, the deformation of the sleeve 3 is absorbed by deformation of the accordion 3d. As a result, the deformation of seal portion 3a is restricted, thereby maintaining the starting motor 1 to be waterproof satisfactorily.

In the above embodiments, it is described that the lead wire 2 is bent into the predetermined shape before molding of the sleeve 3. However, the lead wire 2 may be bent after molding of the sleeve 3 and before being fitted to the magnet switch 9 and the starting motor 1. Since the clearance 4 is provided, the waterproofness between the sleeve 3 and the starting motor 1 is maintained.

The present invention should not be limited to the disclosed embodiments, but may be implemented in other ways without departing from the spirit of the invention.

What is claimed is:

1. A method of assembling a lead wire of a starter comprising steps of:
bending a lead wire for connecting a starting motor and a magnet switch to form a first bent portion and a second bent portion;
integrally molding a sleeve with the lead wire so as to tightly fix to the second bent portion of the lead wire; and
inserting an end of the sleeve facing to the first bent portion of the lead wire to a housing of the starting motor so as to seal an outer periphery of the sleeve and an insertion portion of the housing.

2. The method of claim 1, wherein the inserting step includes inserting an O-ring between the outer periphery of the sleeve and the housing proximate to the insertion portion to seal therebetween.

3. The method of claim 2, wherein the molding step includes integrally molding the O-ring with the sleeve.

4. The method of claim 1, wherein the bending step includes welding an end of the second bent portion to a terminal which is to be connected to the magnet switch.

5. The method of claim 1, wherein the molding step includes forming the sleeve to leave a clearance between the first bent portion of the lead wire and the sleeve.

6. The method of claim 1, wherein the molding step includes forming the sleeve to have a projection at a part which faces the first bent portion of the lead wire.

7. The method of claim 1, wherein the molding step includes forming the sleeve to have accordion structure at a part which faces the first bent portion of the lead wire.

8. The method of claim 1, wherein the molding step includes forming a thin wall portion at a part which faces the first bent portion of the lead wire.

9. The method of claim 1, further comprising a step of connecting the terminal to the magnet switch at a same time as inserting the end of the sleeve into the housing.

10. The method of claim 1, wherein the bending step bends the lead wire in a substantially V-shape to connect the magnet switch and the housing of the starting motor.

11. A method of assembling a lead wire of a starter comprising steps of:
preparing a lead wire, which is to connect a starting motor and a magnet switch, having a predetermined shape that includes a straight portion at a position to be connected to the magnet switch;
molding a sleeve to be fluid-tightly integrated with the straight portion of the lead wire.

12. The method of claim 11, wherein the molding step includes forming the sleeve to have a sealing portion to be fluid-tightly engaged with a housing of the starting motor.

13. The method of claim 12, further comprising a step of fitting the sealing portion of the sleeve to the housing.

14. The method of claim 13, further comprising a step of connecting the straight portion of the lead wire to the magnet switch at a same time as fitting the sealing portion of the sleeve to the housing.

15. The method of claim 11, wherein the molding step includes forming the sleeve to leave a clearance between the sleeve and the lead wire other than a part which is fluid-tightly integrated with the straight portion of the lead wire.

16. The method of claim 11, wherein the molding step includes forming the sleeve to be flexible against the lead wire other than parts which is fluid-tightly integrated with the straight portion of the lead wire and engaged with the housing.

17. The method of claim 11, wherein the fitting step includes inserting an O-ring between the sealing portion of the sleeve and the housing to seal therebetween.

18. The method of claim 17, wherein the molding step includes integrally molding the O-ring with the sleeve.

19. The method of claim 11, wherein the preparing step includes welding a terminal to the straight portion of the lead wire.

20. A method of electrically connecting a motor and a switch fixedly mounted on the motor, the method comprising steps of:
forming an angled lead wire covered with an insulating sleeve thereon except for terminal ends thereof; and
tightly fitting the terminal ends of the angled lead wire to the motor and the switch without deforming a shape of the angled lead wire.
